(19) United States
(12) Patent Application Publication
(10) Pub. No.: US 2015/0071263 A1
(43) Pub. Date: Mar. 12, 2015

(54) CHANNEL QUALITY INDEX (CQI) REPORTING IN WIRELESS NETWORK

(71) Applicant: QUALCOMM Incorporated, San Diego, CA (US)

(72) Inventors: Ming YANG, San Diego, CA (US); Tom Chin, San Diego, CA (US); Guangming SHI, San Diego, CA (US)

(21) Appl. No.: 14/481,700

(22) Filed: Sep. 9, 2014

Related U.S. Application Data
(60) Provisional application No. 61/876,092, filed on Sep. 10, 2013.

(51) Int. Cl. H04W 72/04; H04W 56/00; H04W 72/08

(52) U.S. Cl. CPC H04W 72/0446; H04W 72/082; H04W 56/00
USPC 370/336

(57) ABSTRACT

A method of wireless communication in a wireless network includes transmitting synchronization shift (SS) bits with a channel quality index (CQI) report. The method also includes indicating, via the synchronization shift bits, one or more preferred time slots for receiving a high speed data transmission.

### CROSS REFERENCE TO RELATED APPLICATIONS

The present application claims the benefit of U.S. Provisional Patent Application No. 61/876,092, filed on Sep. 10, 2013, in the names of Ming YANG, et al., the disclosure of which is expressly incorporated by reference herein in its entirety.

### TECHNICAL FIELD

Aspects of the present disclosure relate generally to wireless communication systems, and more particularly, to a novel channel quality index (CQI) reporting method in a wireless network, such as a high speed downlink packet access (HSDPA) network.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes transmitting synchronization shift bits with a channel quality index report. The method also includes indicating, via the synchronization shift bits, one or more preferred time slots of a subframe for receiving a high speed data transmission.

Another aspect of the present disclosure is directed to an apparatus including means for transmitting synchronization shift bits with a channel quality index report. The apparatus also includes means for indicating, via the synchronization shift bits, one or more preferred time slots of a subframe for receiving a high speed data transmission.

In another aspect of the present disclosure, a computer program product for wireless communications is disclosed. The computer program product having a non-transitory computer-readable medium with non-transitory program code recorded thereon. The program code including program code to transmit synchronization shift bits with a channel quality index report. The program code also including program code to indicate, via the synchronization shift bits, one or more preferred time slots of a subframe for receiving a high speed data transmission.

Another aspect of the present disclosure is directed to an apparatus for wireless communications having a memory and one or more processors coupled to the memory. The processor(s) is configured to transmit synchronization shift bits with a channel quality index report. The processor(s) is also configured to indicate, via the synchronization shift bits, one or more preferred time slots of a subframe for receiving a high speed data transmission.

In one aspect of the present disclosure, a method of wireless communication is disclosed. The method includes receiving a first CQI with a first set of synchronization shift bits from a first UE and receiving a second CQI with a second set of synchronization shift bits from a second UE. The method also includes receiving an indication, via the first set of synchronization shift bits, of one or more first preferred time slots of a subframe for receiving a high speed data transmission from the first UE. The method further includes receiving an indication, via the second set of synchronization shift bits, of one or more second preferred time slot of a subframe for receiving a high speed data transmission from the second UE. The method still further includes scheduling the first UE on the one or more first preferred time slots based on the first CQI and scheduling the second UE on the one or more second preferred time slots based on the second CQI.

Another aspect of the present disclosure is directed to an apparatus including means for receiving a first CQI with a first set of synchronization shift bits from a first UE and means for receiving a second CQI with a second set of synchronization shift bits from a second UE. The apparatus also includes means for receiving an indication, via the first set of synchronization shift bits, of one or more first preferred time slots of a subframe for receiving a high speed data transmission from the first UE. The apparatus further includes means for receiving an indication, via the second set of synchronization shift bits, of one or more second preferred time slot of a subframe for receiving a high speed data transmission from the second UE. The apparatus still further includes means for scheduling the first UE on the one or more first preferred time slots based on the first CQI and means for scheduling the second UE on the one or more second preferred time slots based on the second CQI.

In another aspect of the present disclosure, a computer program product for wireless communications is disclosed. The computer program product having a non-transitory computer-readable medium with non-transitory program code recorded thereon. The program code including program code to receive a first CQI with a first set of synchronization shift bits from a first UE and to also receive a second CQI with a second set of synchronization shift bits from a second UE. The program code also including program code to receive an indication, via the first set of synchronization shift bits, of one or more first preferred time slots of a subframe for receiving a high speed data transmission from the first UE. The program code further including program code to receive an indication, via the second set of synchronization shift bits, of one or more second preferred time slot of a subframe for receiving a high speed data transmission from the second UE. The program code still further includes program code to schedule the first UE on the one or more first preferred time slots based on the first CQI and means for to also schedule the second UE on the one or more second preferred time slots based on the second CQI.

Another aspect of the present disclosure is directed to an apparatus for wireless communications having a memory and one or more processors coupled to the memory. The processor(s) is configured to receive a first CQI with a first set of synchronization shift bits from a first UE and to also receive a second CQI with a second set of synchronization shift bits from a second UE. The processor(s) is also configured to receive an indication, via the first set of synchronization shift bits, of one or more first preferred time slots of a subframe for receiving a high speed data transmission from the first UE. The processor(s) is further configured to receive an indication, via the second set of synchronization shift bits, of one or more second preferred time slot of a subframe for receiving a high speed data transmission from the second UE. The processor(s) is still further configured to schedule the first UE on the one or more first preferred time slots based on the first CQI and means for to also schedule the second UE on the one or more second preferred time slots based on the second CQI.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a timing diagram illustrating a conventional scheduling request process.

FIG. 5 is a timing diagram for reporting channel quality information according to aspects of the present disclosure.

FIGS. 6 and 7 are flow diagrams illustrating wireless communication methods for reporting channel quality information according to aspects of the present disclosure.

FIGS. 8 and 9 are block diagrams illustrating examples of a hardware implementation for apparatuses employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

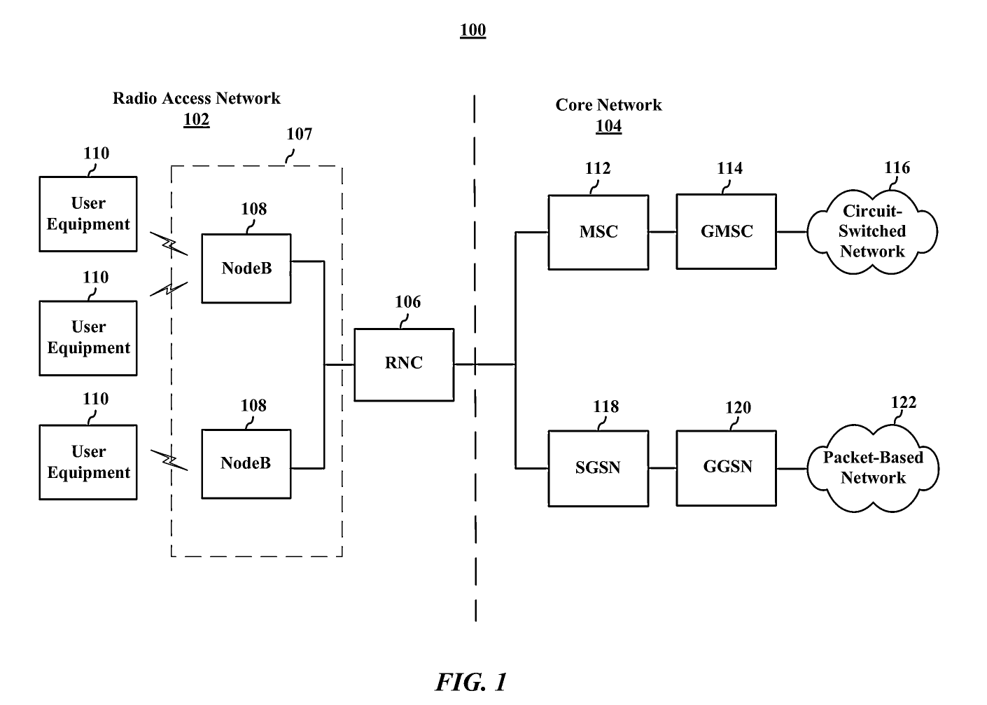

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than speeds used with standard GSM circuit-switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

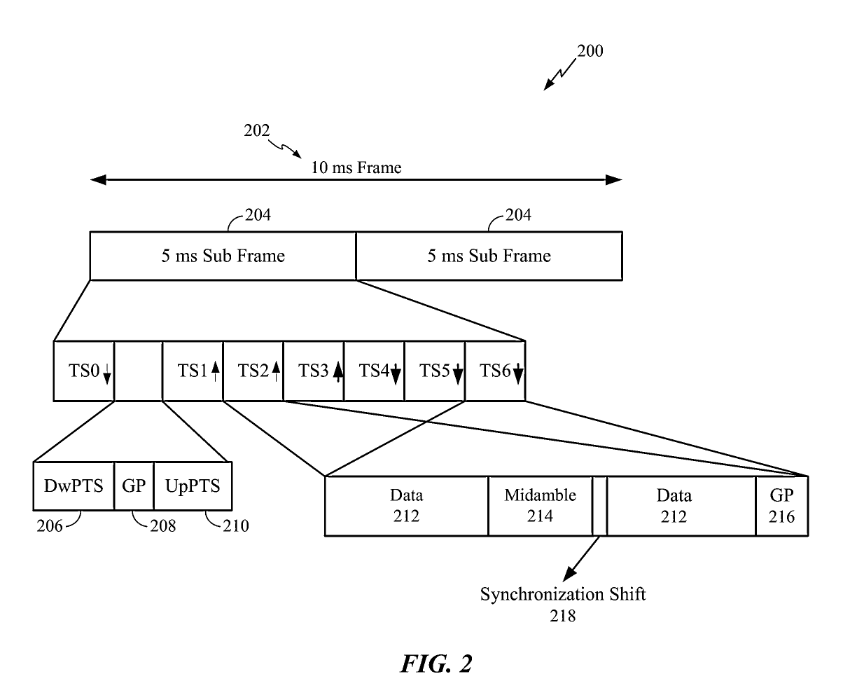

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

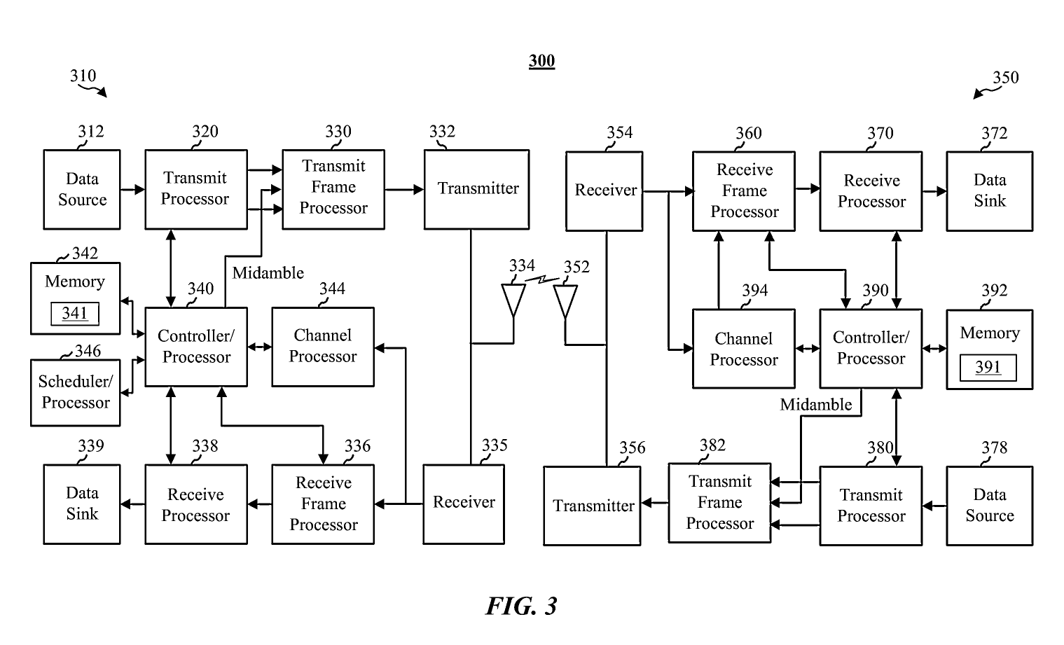

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a channel quality index (CQI) reporting module 391 which, when executed by the controller/processor 390, configures the UE 350 to report a channel quality index. In addition, the memory 342 of the node B 310 may store a CQI receiving module 341, which, when executed by the controller/processor 340, configures the node B 310 to receive a channel quality index. A scheduler/processor 346 at the node B 310 may be used to allocate resources to the UEs and schedule downlink and/or uplink transmissions for the UEs.

### Channel Quality Index (CQI) Reporting in Wireless Network

Aspects of the disclosure are directed to channel quality index (CQI) reporting in a high speed wireless network, such as a time division-high speed downlink packet access (TD-HSDPA) network.

In high speed downlink packet access systems, a grant transmitted via a control channel, such as the high-speed shared control channel (HS-SCCH), may include a modulation and coding scheme (MCS), a channelization code, a time slot, and/or transport block size information for the data bursts. The time slot may indicate when the user equipment (UE) should expect to receive data via a downlink channel, such as the high-speed physical downlink shared channel. In one configuration, each UE includes identification information or data indicator information to indicate which UE should receive a specific data allocation. The data may include a data payload and may be referred to as data bursts and/or user data bursts.

The data transmitted via the downlink channel may be transmitted according to a hybrid automatic repeat request (HARQ) process. In one configuration, a HARQ process with soft combining and incremental redundancy is specified so that a retransmission includes a different set of coded bits than the previous transmission. Thus, at every retransmission, the receiver receives new data indicator information for the data bursts. The downlink channel may also use a cyclic sequence number that increments the specific cyclic sequence number of the UE for each transmission.

An information channel, such as a high-speed shared information channel (HS-SICH), may transmit a channel quality index (CQI) and HARQ acknowledgment or negative-acknowledgment (ACK/NACK) for the data transmission received via the downlink channel. The channel quality index may include a recommended transport block size (RTBS) and a recommended modulation format (RMF), such as quadrature phase shift keying (QPSK).

In a conventional network, the UE reports a channel quality index for all downlink time slots allocated for the downlink channel and signaled via a radio resource control (RRC) message. That is, a scheduler for a base station does not receive channel quality reports for each individual time slot. Therefore, the base station blindly selects time slots for downlink transmissions. The blind selection process may not allocate time slots having the best channel quality. Specifically, the channel quality report does not indicate which downlink time slot is preferred based on channel quality or other measurements, because the reported channel quality index is with respect to all downlink time slots. Thus, it is desirable to provide information to a base station to indicate a preferred time slot, such as the time slot with the strongest channel quality, the highest signal to interference plus noise ratio (SINR), signal to noise ratio (SNR), and/or the lowest interference.

In the present application, the time slots refer to time slots in a subframe, such as the time slots shown in FIG. 2 of the present application. That is, a subframe of the present application includes at least seven time slots.

Some radio access technologies (RATs), such as time division-synchronous code division multiple access (TD-SCDMA), specify a unified frame structure for both uplink transmissions and downlink transmissions. The unified frame structure specifies the joint transmission of the transmit power control (TPC) and the synchronization shift (SS) bits. In some systems, the synchronization shift bits may be used for timing adjustments. Still, base stations may be synchronized via a positioning system, such as GPS. Therefore, the timing adjustments transmitted via synchronization shift bits may be superfluous for a base station that is synchronized via the positioning system. Nonetheless, the synchronization shift bits are still transmitted via the uplink channel due to the standards requirements.

According to aspects of the present disclosure, the synchronization shift bits indicate a preferred time slot to improve the channel quality index reporting. That is, the synchronization shift bits may indicate a specific time slot. The synchronization shift bits may be transmitted via an information channel, such as the high-speed shared information channel. In one configuration, two synchronization shift bits are specified.

The base station may use the synchronization shift bits to select one or more time slots for scheduling downlink transmissions. The preferred time slot may have a strong channel quality index, a high signal to interference plus noise ratio, a high signal to noise ratio, and/or a low interference signal code power (ISCP), etc. In other words, the selected preferred time slots experience improved channel conditions in comparison to the channel conditions of blindly selected time slots. Furthermore, the preferred time slots may improve spectral efficiency and throughput in a wireless network, such as in a high speed downlink packet access network. It should be noted that the reported channel quality indicating a preferred time slot (e.g., synchronization shift bits) is based on a previous data transmission.

In one configuration, a channel quality index measurement report transmits a channel quality index value for all time slots. Additionally, the transmitted synchronization shift bits indicate a time slot with the highest channel quality, the highest signal to interference plus noise ratio, the highest signal to noise ratio, the lowest interference (e.g., ISCP) and/or another indication of signal. Thus, rather than blindly selecting a time slot, in the present configuration, the base station selects a preferred time slot to perform scheduling based on the channel quality index information and the time slot information provided in the synchronization shift bits.

In one example, four downlink time slots are specified (time slots one, four, five and six). In this example, a first UE reports that time slot five is a most preferred time slot and the base station allocates time slot five to the first UE. Furthermore, a second UE may indicate that time slot four is the most preferred time slot. Thus, the base station schedules time slot four for the second UE. As a result, the base station may improve the use of resources by selecting more efficient time slots rather than blindly selecting time slots.

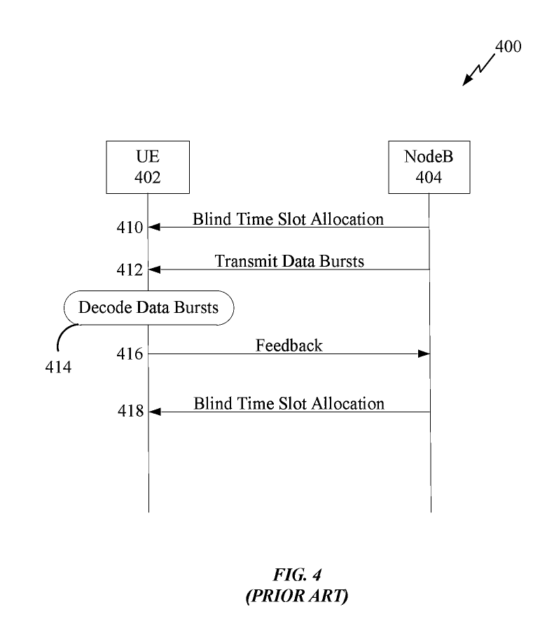

FIG. 4 is a timing diagram 400 illustrating a conventional scheduling request process. As shown in FIG. 4, at time 410, a base station 404 blindly allocates one or more time slots to a UE 402. The time slots may be allocated in a grant and indicate the time slots for receiving downlink data bursts via a data channel. At time 412, the UE 402 receives data bursts from the base station 404. Furthermore, at time 414, the UE 402 decodes the data bursts received from the base station 404 via a downlink channel, such as the high-speed physical downlink shared channel. Moreover, at time 416, the UE transmits feedback information to the base station 404 based on received data bursts. The feedback information may include ACK/NACK information and/or the channel quality index. In this example, the channel quality index is based on all of the allocated time slots. Still, in this example, the UE does not indicate a preferred time slot. Thus, at time 418, for a subsequent transmission, the base station 404 blindly selects one or more time slots for a subsequent downlink data burst transmission.

In high speed downlink packet access, the channel quality information measurement may be based on previous data transmission(s). In one configuration, the base station allocates multiple time slots to the UE. In one configuration, the base station does not allocate all the time slots to a UE. That is, when multiple UEs share multiple time slots, some time slots may be allocated to one UE and other time slots may be allocated to other UEs.

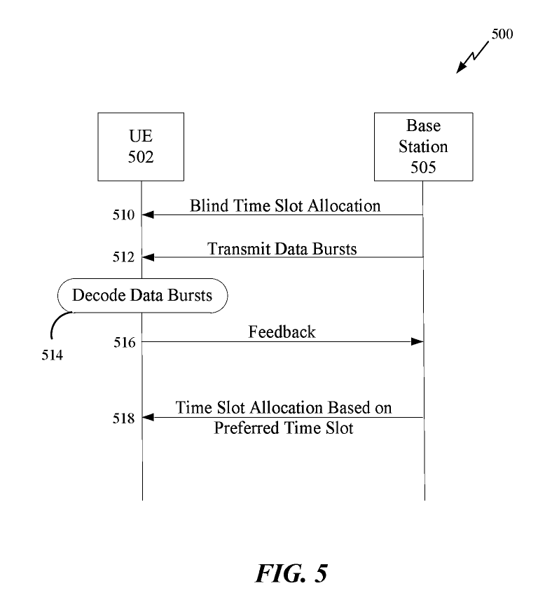

FIG. 5 is a timing diagram 500 illustrating a channel quality index reporting according to an aspect of the present disclosure. As shown in FIG. 5, at time 510, a base station 504 blindly allocates one or more time slots to a UE 502. The time slots may be allocated in a grant and indicate the time slots for receiving downlink data bursts via a data channel. At time 512, the UE 502 receives data bursts from the base station 504. Furthermore, at time 514, the UE 502 decodes the data bursts received from the base station 504 via a downlink channel, such as the high-speed physical downlink shared channel. Moreover, at time 516, the UE transmits feedback information to the base station 504 based on received data bursts. The feedback information may include ACK/NACK information, the channel quality index, and/or a preferred time slot indicated in synchronization shift bits. Thus, at time 518, for a subsequent transmission, the base station 504 selects a time slot for a subsequent downlink data burst transmission based on the preferred time slot indicated in the synchronization shift bits transmitted at time 516.

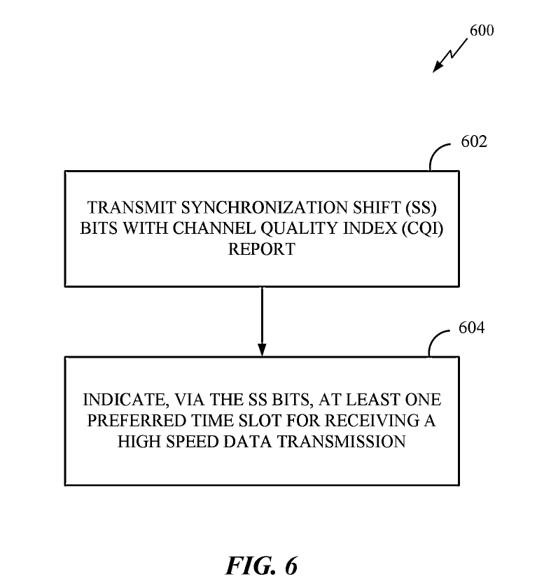

FIG. 6 is a flow diagram illustrating a wireless communication method 600 for reporting channel quality information according to aspects of the present disclosure. In block 602, the UE transmits synchronization shift (SS) bits with a channel quality index (CQI) report. In one configuration, the synchronization shift bits are transmitted via a feedback channel. In another configuration, the feedback channel is a high-speed shared information channel (HS-SICH). In block 604, the UE indicates, via the synchronization shift bits, at least one preferred time slot for receiving a high speed data transmission. In one configuration, the preferred time slot(s) is the time slot having the lowest interference signal code power (ISCP). In another configuration, the preferred time slot(s) has a highest signal to interference plus noise ratio (SINR) and/or signal noise ratio (SNR).

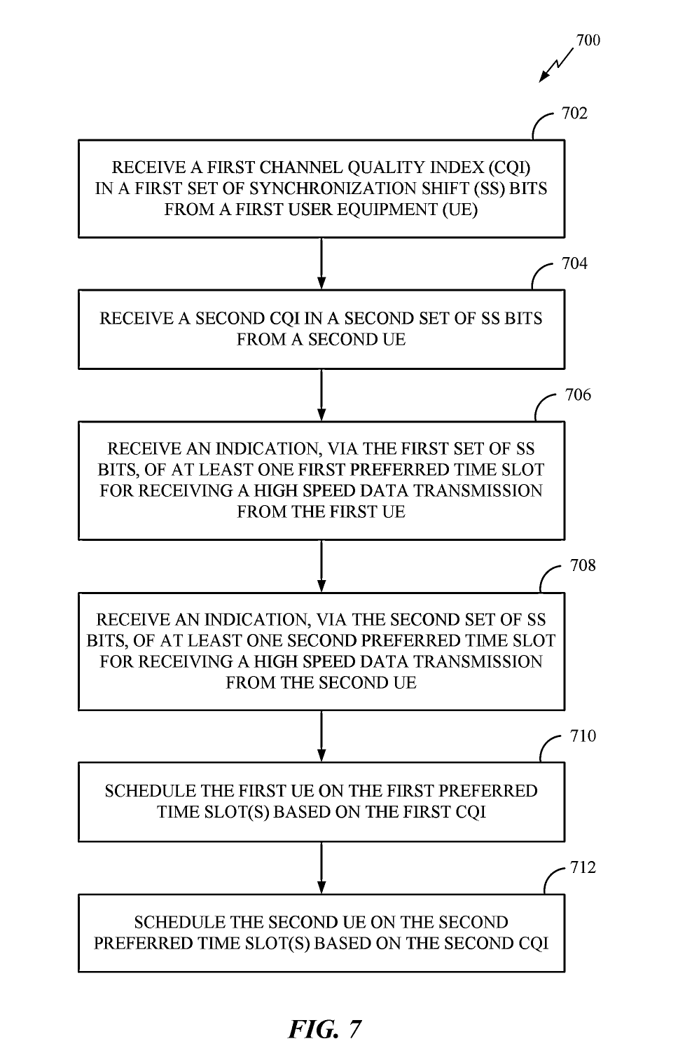

FIG. 7 is a flow diagram illustrating another wireless communication method 700 for reporting channel quality information according to aspects of the present disclosure. In block 702, the NodeB receives a first channel quality index (CQI) in a first set of synchronization shift (SS) bits from a first UE. In block 704, the NodeB receives a second channel quality index in a second set of synchronization shift bits from a second UE. In one configuration, the first set and the second set of synchronization shift bits each include two synchronization shift bits. In one configuration, the receiving of the first and second channel quality indices in the first set and the second set of synchronization shift bits from the first UE and the second UE occurs via a feedback channel. The feedback channel may be, for example, a high-speed shared information channel (HS-SICH).

In block 706, the NodeB receives an indication, via the first set of synchronization shift bits, of at least one first preferred time slot for receiving a high speed data transmission from the first UE. In block 708, the Node B receives an indication, via the second set of synchronization shift bits, of at least one second preferred time slot for receiving a high speed data transmission from the second UE. In one configuration, the first and second preferred time slots have the lowest interference signal code power (ISCP). In another configuration, the first and second preferred time slots have a highest signal to interference plus noise ratio (SINR) and/or signal noise ratio (SNR).

In block 710, the NodeB schedules the first UE on the first preferred time slot(s) based on the first channel quality index. In block 712, the NodeB schedules the second UE on the second preferred time slot(s) based on the second channel quality index. In one configuration, the NodeB may actually be multiple NodeBs.

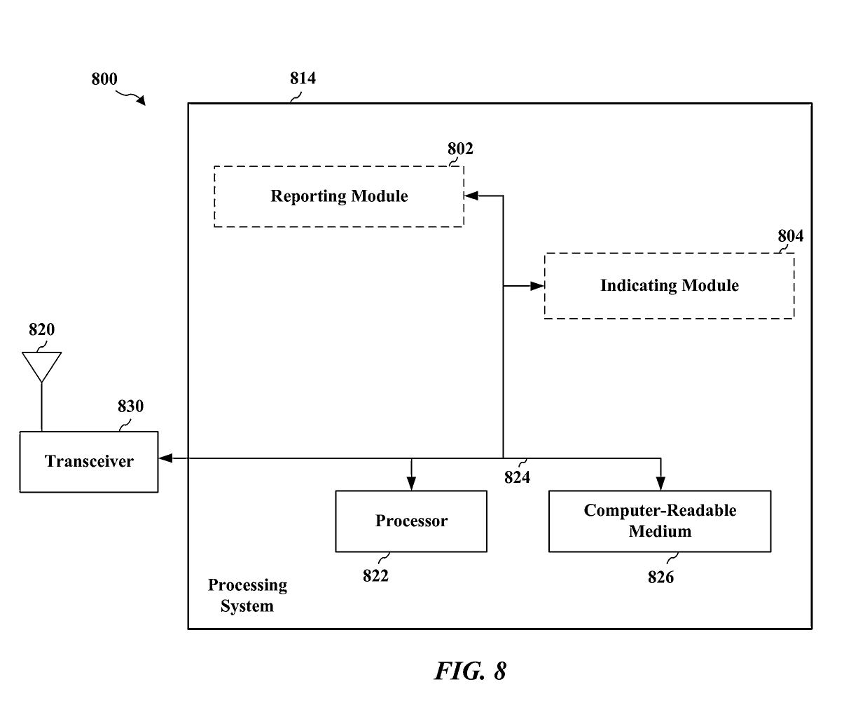

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the reporting module 802, the indicating module 804, and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a reporting module 802 for reporting a channel quality index (CQI) in synchronization shift (SS) bits. The processing system 814 also includes an indicating module 804 for indicating, via the synchronization shift bits, at least one preferred time slot for receiving a high speed data transmission. The modules may be software modules running in the processor 822, resident/stored in the computer-readable medium 826, one or more hardware modules coupled to the processor 822, or some combination thereof. The processing system 814 may be a component of the UE 350 and may include the memory 392, and/or the controller/processor 390.

In one configuration, an apparatus such as an UE 350 is configured for wireless communication including means for reporting. In one aspect, the above means may be the antennas 352, the transmitter 356, the transmit processor 380, the controller/processor 390, the memory 392, the channel quality index reporting module 391, the reporting module 802, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for indicating. In one aspect, the above means may be the antennas 352, the transmitter 356, the transmit processor 380, the controller/processor 390, the memory 392, the channel quality index reporting module 391, the indicating module 804, the processor 822, and/or the processing system 814 configured to perform the functions recited by the aforementioned means. In another aspect, the aforementioned means may be a module or any apparatus configured to perform the functions recited by the aforementioned means.

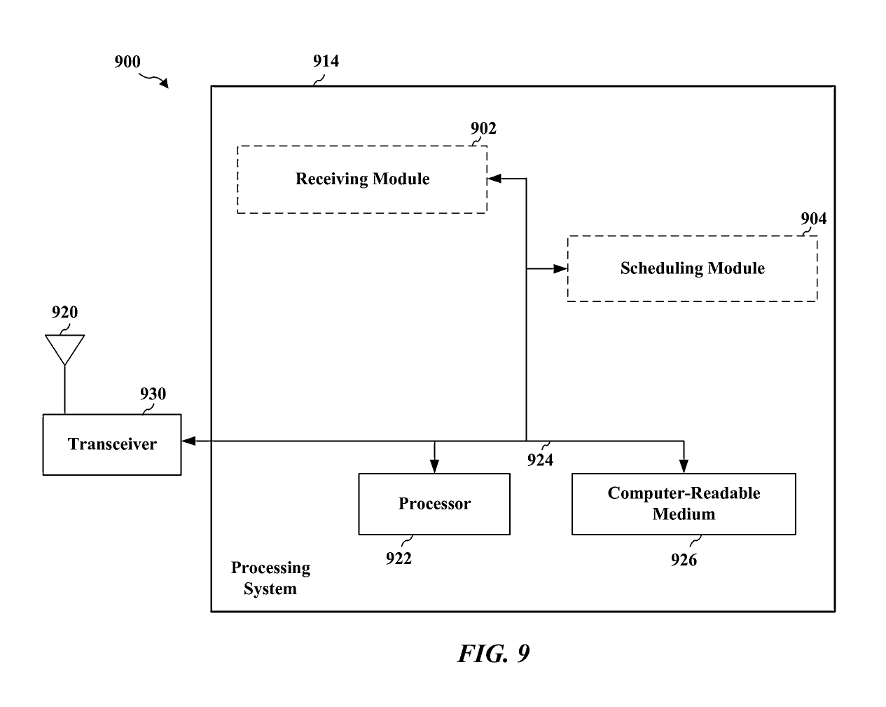

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922, the receiving module 902, the scheduling module 904, and the computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a receiving module 902 for receiving a first channel quality index (CQI) in a first set of synchronization shift (SS) bits from a first user equipment (UE), receiving a second CQI in a second set of synchronization shift Synchronization shift bits from a second UE, receiving an indication, via the first set of synchronization shift bits, of at least one first preferred time slot for receiving a high speed data transmission from the first UE, and receiving an indication, via the second set of Synchronization shift bits, of at least one second preferred time slot for receiving a high speed data transmission from the second UE.

The processing system 914 also includes a scheduling module 904 for scheduling the first UE on the at least one first preferred time slot based at least in part on the first CQI, and scheduling the second UE on the at least one second preferred time slot based at least in part on the second CQI.

The modules may be software modules running in the processor 922, resident/stored in the computer-readable medium 926, one or more hardware modules coupled to the processor 922, or some combination thereof. The processing system 914 may be a component of the node B 310 and may include the memory 342, and/or the controller/processor 340.

In one configuration, an apparatus such as a node B 310 is configured for wireless communication including means for receiving. In one aspect, the above means may be the antennas 334, the receiver 335, the receive processor 338, the controller/processor 340, the memory 342, the CQI receiving module 341, the receiving module 902, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for scheduling. In one aspect, the above means may be the antennas 334, the transmitter 332, the transmit processor 320, the controller/processor 340, the memory 342, the scheduling module 904, the processor 922, and/or the processing system 914 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems, and/or TD-HSDPA. As those skilled in the art will readily appreciate, various aspects described throughout this disclosure may be extended to other telecommunication systems, network architectures and communication standards. By way of example, various aspects may be extended to other UMTS systems such as W-CDMA, high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a wireless network, comprising:
transmitting synchronization shift (SS) bits with a channel quality index (CQI) report; and
indicating, via the synchronization shift bits, at least one preferred time slot of a subframe for receiving a high speed data transmission.

2. The method of claim 1, in which the at least one preferred time slot has a lowest interference signal code power (ISCP) in comparison to the ISCP of other time slots.

3. The method of claim 1, in which the at least one preferred time slot has at least a highest signal to interference plus noise ratio (SINR) in comparison to the SINR of other time slots, a highest signal noise ratio (SNR) in comparison to the SNR of other time slots, or a combination thereof.

4. The method of claim 1, in which the synchronization shift bits are transmitted via a feedback channel.

5. The method of claim 4, in which the feedback channel is a high-speed shared information channel (HS-SICH).

6. A method of wireless communication in a wireless network, comprising:
receiving a first channel quality index (CQI) with a first set of synchronization shift bits from a first user equipment (UE);
receiving a second CQI with a second set of synchronization shift bits from a second UE;
receiving an indication, via the first set of synchronization shift bits, of at least one first preferred time slot of a subframe for receiving a high speed data transmission from the first UE;
receiving an indication, via the second set of synchronization shift bits, of at least one second preferred time slot of a subframe for receiving a high speed data transmission from the second UE;
scheduling the first UE on the at least one first preferred time slot based at least in part on the first CQI; and
scheduling the second UE on the at least one second preferred time slot based at least in part on the second CQI.

7. The method of claim 6, in which the at least one first preferred time slot and the at least one second preferred time slot have a lowest interference signal code power (ISCP) in comparison to the ISCP of other time slots.

8. The method of claim 6, in which the at least one first preferred time slot and the at least one second preferred time slot have at least a highest signal to interference plus noise ratio (SINR) in comparison to the SINR of other time slots, a highest signal noise ratio (SNR) in comparison to the SNR of other time slots, or a combination thereof.

9. The method of claim 6, in which the synchronization shift bits are received via a feedback channel.

10. The method of claim 9, in which the feedback channel is a high-speed shared information channel (HS-SICH).

11. An apparatus for wireless communication in a wireless network, the apparatus comprising:
a memory unit; and
at least one processor coupled to the memory unit, the at least one processor being configured:
to transmit synchronization shift (SS) bits with a channel quality index (CQI) report; and
to indicate, via the synchronization shift bits, at least one preferred time slot of a subframe for receiving a high speed data transmission.

12. The apparatus of claim 11, in which the at least one preferred time slot has a lowest interference signal code power (ISCP) in comparison to the ISCP of other time slots.

13. The apparatus of claim 11, in which the at least one preferred time slot has a at least a highest signal to interference plus noise ratio (SINR) in comparison to the SINR of other time slots, a highest signal noise ratio (SNR) in comparison to the SNR of other time slots, or a combination thereof.

14. The apparatus of claim 11, in which the synchronization shift bits are transmitted via a feedback channel.

15. The apparatus of claim 14, in which the feedback channel is a high-speed shared information channel (HS-SICH).

16. An apparatus for wireless communication in a wireless network, the apparatus comprising:
a memory unit; and
at least one processor coupled to the memory unit, the at least one processor being configured:
to receive a first channel quality index (CQI) with a first set of synchronization shift bits from a first user equipment (UE);
to receive a second CQI with a second set of synchronization shift bits from a second UE;
to receive an indication, via the first set of synchronization shift bits, of at least one first preferred time slot of a subframe for receiving a high speed data transmission from the first UE;
to receive an indication, via the second set of synchronization shift bits, of at least one second preferred time slot of a subframe for receiving a high speed data transmission from the second UE;
to schedule the first UE on the at least one first preferred time slot based at least in part on the first CQI; and
to schedule the second UE on the at least one second preferred time slot based at least in part on the second CQI.

17. The apparatus of claim 16, in which the at least one first preferred time slot and the at least one second preferred time slot have a lowest interference signal code power (ISCP) in comparison to the ISCP of other time slots.

18. The apparatus of claim 16, in which the at least one first preferred time slot and the at least one second preferred time slot have at least a highest signal to interference plus noise ratio (SINR) in comparison to the SINR of other time slots, a highest signal noise ratio (SNR) in comparison to the SNR of other time slots, or a combination thereof.

19. The apparatus of claim 16, in which the synchronization shift bits are received via a feedback channel.

20. The apparatus of claim 19, in which the feedback channel is a high-speed shared information channel (HS-SICH).
